(19) United States
(12) Patent Application Publication
(10) Pub. No.: US 2023/0346051 A1
(43) Pub. Date: Nov. 2, 2023

(54) Wearable Assembly, Apparatus and Method

(71) Applicant: Prevayl Innovations Limited, Manchester, Greater Manchester (GB)

(72) Inventors: Michael John Lynch, Cheshire (GB); Rhiannon Jacqueline Goswell, Manchester, Greater Manchester (GB)

(21) Appl. No.: 18/041,197

(22) PCT Filed: Sep. 8, 2021
(86) PCT No.: PCT/GB21/52311

§ 371 Date: Feb. 9, 2023

(30) Foreign Application Priority Data
Sep. 10, 2020 (GB) 2014231.1

(51) Int. Cl. A41D 1/00; G06K 19/07; G06K 19/06

(52) U.S. Cl. CPC A41D 1/002; G06K 19/0716; G06K 19/06112

(57) ABSTRACT

The wearable assembly (100) comprises an electronics module (4). The electronics module comprises a controller arranged to interface with sensing components (2, 3) so as to sense activity data associated with a user wearing the electronics module. The electronics module has an arrangement of coloured LEDs which can also flash in a predetermined sequence and form a machine-readable code on the external housing of the electronics module which acts as an electronics module identifier. The LED arrangement also acts as an augmented reality marker and enables a wearer of the electronics module to be identified at a distance and activity data and other information displayed in an augmented reality display on a user electronic device such as a mobile phone (400).

The present invention is directed towards a wearable assembly, apparatus and method. The present invention is further directed towards a wearable assembly, apparatus and method for use in a data gathering and display, particularly, although not exclusively for biosignals and activity data for a wearer of a wearable assembly.

### BACKGROUND

Wearable articles, such as garments, incorporating sensors are wearable electronics used to measure and collect information from a wearer. Such wearable articles are commonly referred to as ‘smart clothing’. It is advantageous to measure biosignals of the wearer during exercise, or other scenarios.

It is known to provide a garment, or other wearable article, to which a device (i.e. an electronics module, and/or related components) is attached in a prominent position, such as on the chest or between the shoulder blades. The device may be detachable.

The device is configured to process the incoming signals, and the output from the processing is stored and/or displayed to a user in a suitable way.

A sensor senses a biosignal such as electrocardiogram (ECG) and the biosignals are coupled to the device, via an interface.

The device includes drive and sensing electronics comprising components and associated circuitry, to provide the required functionality.

Data output from the device can be sent wirelessly, for example using Bluetooth® or via mobile/cellular radio communication, or a WiFi communication, received at a remote location, processed with data being displayed or otherwise communicated to a person located remotely.

The data may be, for example, biosignals providing activity data such as the wearer's heart rate, and body temperature as well as additional data such as location data and identification data.

It would be desirable to provide a mechanism for intuitively displaying such data recorded by the sensor of the wearable garment.

### SUMMARY

According to an aspect of the present invention, there is provided an electronics module for a wearable assembly. The electronic module comprises a housing, a controller housed within the housing and arranged to interface with a sensing component of the wearable assembly so as to receive activity data associated with a wearer wearing the wearable assembly, and a communicator housed within the housing and arranged to communicate a first electronics module identifier and an associated second electronics identifier to an external apparatus over a wireless communication protocol, wherein the second electronics module identifier comprises a machine-readable code, the machine-readable code being readable externally of the housing.

The second electronics module identifier may comprise an arrangement of light emitting diodes. The light emitting diodes may be configured to illuminate in a pre-determined pattern or sequence.

The arrangement may include an infra-red light emitting diode.

The second electronics module identifier may be a fiducial marker.

According to a second aspect of the present invention, there is provided a method comprising: reading a first electronics module identifier and an associated second electronics module identifier for at least one electronics module;
storing the associated the first and second electronics module identifiers;
obtaining activity data from one of the at least one electronics module;
obtaining a second electronics module identifier from one of the least one electronics module;
identifying the first electronics module identifier associated with the obtained second electronics module identifier;
accessing activity data for the identified first electronics module identifier; and
displaying the accessed activity data for the identified first electronics module identifier, wherein the obtaining the second electronics module identifier comprises reading a machine-readable code of the one of the at least one electronics module externally of the at least one electronics module.

The step of reading the machine-readable code may comprise imaging a visual marker provided on a housing of the at least one electronics module.

The step of reading the machine-readable code may comprise detecting a non-visual signal emitted by the at least one electronics module.

The method may further comprise displaying the activity data along with identifying information for the wearer wearing the at least one electronics module.

The activity data may be displayed in accordance with the second electronics module identifier.

The method may further comprise reading at least one secondary display marker on the wearable article and displaying the activity data in accordance with at least one secondary marker.

The method may further comprise receiving activity data and first and second electronics module identifiers from a plurality of electronics modules, and for at least one of the plurality of electronics modules, obtaining a second electronics module identifier, the method further including the steps of: identifying a first electronics module identifier associated with the at least one of the plurality of electronics modules; accessing activity data for the identified first electronics module identifier associated with the at least one of the plurality of electronics modules; and displaying the accessed activity for the identified electronics module identifier associated with the at least one of the plurality of electronics modules.

The method may further comprise displaying the activity data for the plurality of electronics modules along with identifying information for the users associated with the plurality of electronics modules.

The activity data and the electronics module identifier may be received indirectly from the at least one electronics module via an external apparatus.

The obtained second electronics module identifier may be transmitted to an external apparatus, and the step of the identifying the first electronics module and accessing the activity data is carried out at the external apparatus, the method may further include the step of transmitting the activity data from the external device for display.

According to another aspect of the present invention, there is provided a computer program comprising instructions which, when executed by a computer apparatus, cause the computer apparatus to perform the method of the second aspect of the invention.

According to a fourth aspect of the present invention, there is provided a wearable assembly including an electronics module of the first aspect of the present invention.

According to a fifth aspect of the present invention there is provided an apparatus comprising:
a first reader arranged to read a first electronics module identifier and an associated second electronics module identifier for an electronics module;
a second reader arranged to read a second electronics module identifier from at least one electronics module;
a memory for storing the associated the first and second electronics module identifiers; and
a display,

a controller configured to:
obtain activity data from one of the at least one electronics module;
obtain the second electronics module identifier read by the second reader from the at least one electronics module;
identify the first electronics module identifier associated with the obtained second electronics module;
access activity data for the at least one first electronics module identifier; and
display the accessed activity data for the at least first electronics module identifier on the display, wherein the second reader may be arranged to read a machine-readable code of the at least one electronics module externally of a housing of the at least one electronics module.

The second reader may be an image capturing device configured to image a visible machine-readable code on the housing of the at least one electronics module.

The second reader may be an infra-red sensor configured to detect an infra-red signal emitted by the second electronics module identifier to determine the machine-readable code from the detected infra-red signal.

The controller may be operable to obtain activity data from the at least one electronics module; and to identify a wearer wearing the at least one electronics module by identifying the second electronics module identifier associated with the electronics module identifier.

The apparatus may include a display and the controller is configured to display the activity data along with identifying information for the wearer.

The present invention has the advantage of an improved wearable assembly, apparatus and method. The wearable article of the wearable assembly uses a second electronics module identifier which can be read at a greater distance so is particularly applicable to scenarios in which the wearer of the wearable article is further away, for example on a football pitch. As the second electronics module identifier is, it can be provided over a greater portion of the wearable article which enables the identifier more easily readable. It also enables a greater portion of the wearable article to include additional markings such as sponsor details, players' names and the like.

### BRIEF DESCRIPTION OF THE DRAWINGS

Examples of the present disclosure will now be described with reference to the accompanying drawings, in which:

FIG. 1 shows a schematic diagram of an example system according to aspects of the present disclosure;

FIG. 2 shows a schematic diagram of an example electronics module according to aspects of the present disclosure;

FIG. 3 shows a schematic diagram of an example user electronics device according to aspects of the present disclosure;

FIG. 4 shows a schematic diagram of a cross section through a portion of a wearable article for a wearable assembly according to aspects of the present disclosure;

FIG. 5 shows a schematic representation of an electronics module for a wearable article according to aspects of the present disclosure;

FIG. 6 shows an example interface according to aspects of the present disclosure;

FIG. 7 shows a flow diagram for another example method according to aspects of the present disclosure;

FIG. 8 shows a swim lane diagram for yet another example method according to aspects of the present disclosure;

FIG. 9 shows a swim lane diagram for yet another example method according to aspects of the present disclosure; and

FIG. 10 shows a swim lane diagram for yet another example method according to aspects of the present disclosure;

FIG. 11 shows a swim lane diagram for yet another example method according to aspects of the present disclosure; and

FIG. 12 shows a schematic representation of a second embodiment of an electronics module for a wearable article according to aspects of the present disclosure.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings but are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise.

“Wearable article” as referred to throughout the present disclosure may refer to any form of electronic device which may be worn by a user such as a smart watch, necklace, bracelet, or glasses. The wearable article may be a textile article. The wearable article may be a garment. The garment may refer to an item of clothing or apparel. The garment may be a top. The top may be a shirt, t-shirt, blouse, sweater, jacket/coat, or vest. The garment may be a dress, brassiere, shorts, pants, arm or leg sleeve, vest, jacket/coat, glove, armband, underwear, headband, hat/cap, collar, wristband, stocking, sock, or shoe, athletic clothing, swimwear, wetsuit or drysuit. The wearable article/garment may be constructed from a woven or a non-woven material. The wearable article/garment may be constructed from natural fibres, synthetic fibres, or a natural fibre blended with one or more other materials which can be natural or synthetic. The yarn may be cotton. The cotton may be blended with polyester and/or viscose and/or polyamide according to the particular application. Silk may also be used as the natural fibre. Cellulose, wool, hemp, linen and jute are also natural fibres that may be used in the wearable article/garment. Polyester, polycotton, nylon and viscose are synthetic fibres that may be used in the wearable article/garment. The garment may be a tight-fitting garment. Beneficially, a tight-fitting garment helps ensure that the sensor devices of the garment are held in contact with or in the proximity of a skin surface of the wearer. The garment may be a compression garment. The garment may be an athletic garment such as an elastomeric athletic garment.

“Biosignal” may refer to any signal in a living being that can be measured and monitored. The term “biosignal” is not limited to electrical signals and can refer to other forms of non-electrical biosignals. Sensing components may be used for measuring one or a combination of bioelectrical, bioimpedance, biochemical, biomechanical, bioacoustics, biooptical or biothermal signals of the user. The bioelectrical measurements include electrocardiograms (ECG), electrogastrograms (EGG), electroencephalograms (EEG), and electromyography (EMG). The bioimpedance measurements include plethysmography (e.g., for respiration), body composition (e.g., hydration, fat, etc.), and electroimpedance tomography (EIT). The biomagnetic measurements include magnetoneurograms (MNG), magnetoencephalography (MEG), magnetogastrogram (MGG), magnetocardiogram (MCG). The biochemical measurements include glucose/lactose measurements which may be performed using chemical analysis of the user's sweat. The biomechanical measurements include blood pressure. The bioacoustics measurements include phonocardiograms (PCG). The biooptical measurements include orthopantomogram (OPG). The biothermal measurements include skin temperature and core body temperature measurements.

The garment comprises a sensing component or more typically a plurality of sensing components. The activity data obtained by the sensing components is transmitted by an electronics module of the garment to a server. The electronics module may be in the form of a detachable electronic device that can be inserted into, for example, a pocket of the garment.

The activity data may comprise any or a combination of the different example measurements described above.

The electronics module may be associated with a first person referred to as the “wearer”. A second person referred to as the “user” is in possession of a user electronic device such as a mobile phone. The second person may desire to see activity data for the wearer as recorded by the sensors of the garment. For example, the user may be a sports coach that may desire to view metrics such as the wearer's heartrate, respiration levels and hydration levels of the wearer. The user may also be a healthcare professional such as a physiotherapist or doctor.

In some examples, the “user” and the “wearer” refer to the same person.

According to aspects of the present invention, there is provided an electronics module having an augmented reality (AR) marker.

Preferably, the marker is a fiducial marker. Fiducial markers can be used as part of an augmented reality (AR) application, for example to provide an easily visible display of activity data which can be displayed or overlaid over an image of a wearer of the garment as taken by an imaging device, for example a camera housed within an electronic device such as a mobile phone, and operated by a user, or by one of more remote cameras located within the wearer's environment.

Augmented reality (AR) markers are cues which trigger the display of the virtual information. The cues may be visual cues. Markers are trained beforehand so that they can be recognized later in the camera stream. After an AR marker is recognized, its position, scale, and rotation are derived from visual cues and transferred to the virtual information.

In the present exemplar application, a sports coach can simply take a video of a sports person during activity at a remote distance and display the activity data within the video image showing on their mobile phone.

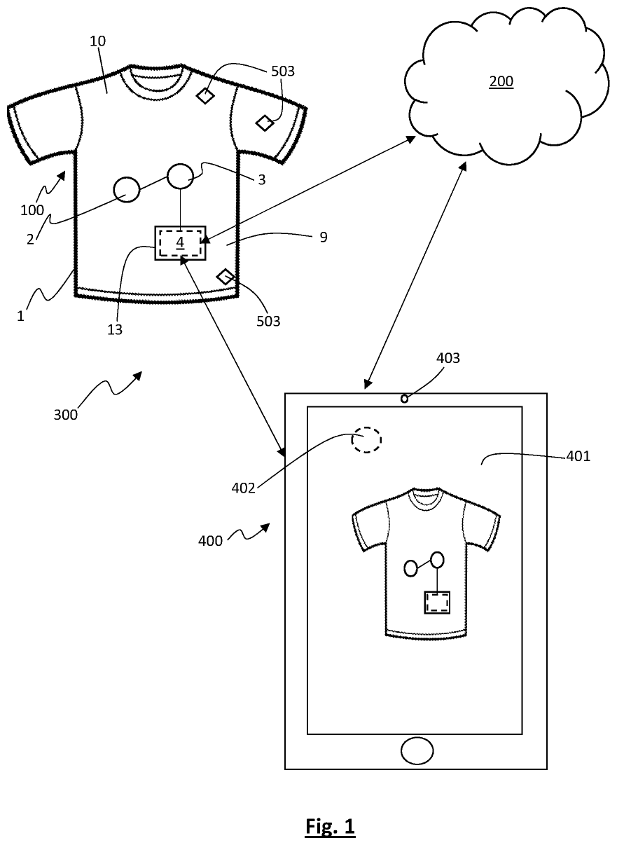

Referring to FIG. 1, there is shown an example garment 1, user electronic device 400, and server 200 in accordance with aspects of the present invention.

The garment 1 in the example of FIG. 1 is in the form of a T-shirt.

The garment 1 has a main body portion 10 and comprises sensing components 2, 3 arranged to monitor the activity of the wearer of the garment 1. The sensing components 2, 3 are communicatively coupled to the electronics module 4 and arranged to communicate activity data to the server 200 and/or the user electronic device 400. In the example described herein, two sensing components 2, 3 are described, but it will be evident to a person skilled in the art, that any number of sensing components can be used, depending upon requirements and application.

The sensing components 2, 3 are provided on an inner face 5 of the garment 1 so that they lie adjacent the skin of the wearer. This enables the sensing components 2, 3 to measure the activity data such as biosignals for the wearer of the garment 1.

The sensing components 2, 3 may be arranged to sense one or more signals external to the user or wearer.

In an alternative, sensing components may also comprise any or a combination of a temperature sensor, a camera, a location tracking module such as a GPS module, and a chemical sensor.

As mentioned above, activity data may comprise any or a combination of the different example measurements described above.

The garment 1 and electronics module 4 comprise a wearable assembly 100. The wearable assembly 100, user electronic device 400, and server 200 form an example system 300 in accordance with aspects of the invention.

The electronics module 4 may be located on any suitable portion of the garment 1 as required by the application. In this exemplar embodiment, the electronics module 4 can be held in an electronics module holder in the form of a pocket 13 on the outer surface 7 of the garment 1.

When disposed in the pocket 13, the electronics module 4 is arranged to integrate with the sensing components of garment 1 and receive activity data from the sensing components 2, 3. The electronics module 4 is removable from the garment 1.

The present disclosure is not limited to electronics module holders in the form of a pockets 6. Instead, other mechanism for releasably mechanically coupling the electronics module 4 to the garment 1 may be provided. The mechanical coupling of the electronics module 4 to the garment 1 may be provided by a mechanical interface such as a clip, a plug and socket arrangement, etc. The mechanical coupling or mechanical interface may be configured to maintain the electronics module 4 in a particular orientation with respect to the garment 1 when the electronics module 4 is coupled to the garment 1. This may be beneficial in ensuring that the electronics module 4 is securely held in place with respect to the garment 1 and/or that any electronic coupling of the electronics module 4 and the garment 1 (or a component of the garment 1) can be optimized. The mechanical coupling may be maintained using friction or using a positively engaging mechanism, for example.

Beneficially, the removable electronics module 4 may contain all of the components required for data transmission and processing such that the garment 1 only comprises the sensing components and communication pathways. In this way, manufacture of the garment 1 may be simplified. In addition, it may be easier to clean a garment 1 which has fewer electronic components attached thereto or incorporated therein. Furthermore, the removable electronics module 4 may be easier to maintain and/or troubleshoot than embedded electronics. The electronics module 4 may comprise flexible electronics such as a flexible printed circuit (FPC). The electronics module 4 may be configured to be electrically coupled to the garment 200.

The electronics module 4 transmits the activity data to an external apparatus such as the server 200 and/or the user electronic device 400.

In the exemplar embodiment described herein, the user electronic device 400 is a cellular radio telephone or tablet with wireless communication capabilities as will be described in further detail below.

In environments such as team sports or workplace settings, there may be a number of different wearers associated different wearable assemblies 100 at the same time.

As mentioned above, the term ‘wearer’ is a person who is carrying the electronics module 4 for a period of time. As such, the electronics module 4 is associated with the wearer, for example by being carried in a pocket 13 of the garment 1 or other wearable article, at that time.

Each of the wearable assemblies 100 will have a different electronics module 4 transmitting data, such as activity data, to the same external apparatus such as the user electronic device 400 and/or the server 200. The data transmitted by the electronics module 4 will be associated with a first electronics module identifier that uniquely identifies the electronics module 4. The first electronics module identifier may be, for example, a communication address for the electronics module 4.

Generally, it is desirable that there is no fixed association between electronics module 4 and a garment 1. This provides greater flexibility in a sports or workplace setting. A pool of electronics modules 4 may be maintained by a central provider. This enables one electronics module 4 to be, over time, used with different garments 1 worn by different wearers. Because there is no fixed association between a wearer and a particular electronics module 4 incorporated into the pocket 13 of the garment 1, it will be challenging and may not be possible (depending on the number of electronics modules, for example) for the user electronic device 400 to confidently determine which wearer, received activity data relates to. This limits the utility of the received activity data as it is not possible to provide insights and analysis for a particular wearer. This is particularly problematic where the wearers are distant from the user to the extent that the user electronic device 400 is not able to directly communicate with the electronics module 4 to access the activity data in real time.

The electronics module 4 includes a second electronics module identifier 500.

In the present exemplar embodiment, the second electronics module identifier 500 is an arrangement of light-emitting diodes (LEDs) that defines a machine-readable code that is readable remotely, for example by the user electronic device 400.

The machine-readable code comprises an LED configuration comprising a sequence of colours and/or flashes that is assigned to that electronics module 4. Permutations of possible LED configurations are stored in a look up table in memory 18 of the controller 16.

Upon start up, the electronics module 4 is assigned a particular available configuration and the assigned configuration is stored in memory 18 of a controller 16 of the electronics module 4.

The controller 16 is configured to cause the LED arrangement to adopt the assigned configuration whilst it is in use.

Alternatively, the machine-readable code could be assigned during manufacturing along with other identifiers such as the MAC address and PCB barcode information. The second electronics module identifier 500 can therefore effectively act as an identifier of the wearer of the garment 1 with which the electronics module 4 is associated during an allocated period of time. That is, the second electronics module identifier may be a unique identifier for a particular wearer during a specific period of use whilst the electronics module 4 is being used with the garment 1 worn by a wearer of the garment 1. Typically, this is because the electronics module 4 is being used by the wearer to obtain biometric activity data when attached to the garment 1 e.g. when held in the pocket 13.

The first electronics module identifier is different to the second electronics module identifier 500. Whilst both are associated with the electronics module 4, the first electronics module identifier identifies the electronics module itself in its communications with the server 200 and/or the user electronics module 400 and is used to identify data such as activity data with a particular electronics module 4. The second electronics module identifier is configured to remotely identify the electronics module 4 which is associated with the wearer using the electronics module 4 at the time. It may also act as an AR marker.

In an example operation, during a set-up period, the user electronic device 400 communicates with the electronics module 4 to obtain the first electronics module identifier and the second electronics module identifier from the electronics module 4.

The user electronic device 400 may be brought into proximity with the pocket 13 to obtain the first electronics module identifier and the second electronics module identifier from the electronics module 4.

Both the second electronics module identifier and the first electronics module identifier are associated with each other and stored in relevant memory, such as the memory 404 of the user electronics device 400.

The present disclosure means that limited manual input is required to form an association between an electronics module identifier and a wearer of the electronics module during a period of use by the wearer. A wearer or other user is not required to manually input or select first and second electronics module identifiers via an interface of the user electronic device 400 and is not required to form the association manually. Instead, the user, or the wearer, may simply tap the user electronic device 400 against the wearable assembly 100 so that the user electronic device 400 can read the first electronics module identifier and the second electronics module identifier 500. The user may be prompted to perform these steps by an application running on the user electronic device 400. Once the first electronics module identifier and second electronics module identifier are obtained, the user electronic device 400 may automatically form the association between the first electronics module identifier and the second electronics module identifier 500 without further user input.

The present disclosure is not limited to electronics modules 4 that communicate directly with the user electronic devices 400 and instead may communicate with any electronic device capable of communicating with the electronics module 4, for example via an external apparatus over a wired or wireless communication network, such as the server 200. Therefore, the electronics module 4 may transmit the first electronics module identifier and second electronics module identifier 500 to the external apparatus, such as the server 200, which maintains a database to store the two associated identifiers therein,

The user electronic device 400 may be a wireless device or a wired device. The wireless/wired device may be a mobile phone, tablet computer, gaming system, MP3 player, point-of-sale device, or wearable device such as a smart watch. A wireless device is intended to encompass any compatible mobile technology computing device that connects to a wireless communication network, such as mobile phones, mobile equipment, mobile stations, user equipment, cellular phones, smartphones, handsets or the like, wireless dongles or other mobile computing devices. The wireless communication network is intended to encompass any type of wireless such as mobile/cellular networks used to provide mobile phone services.

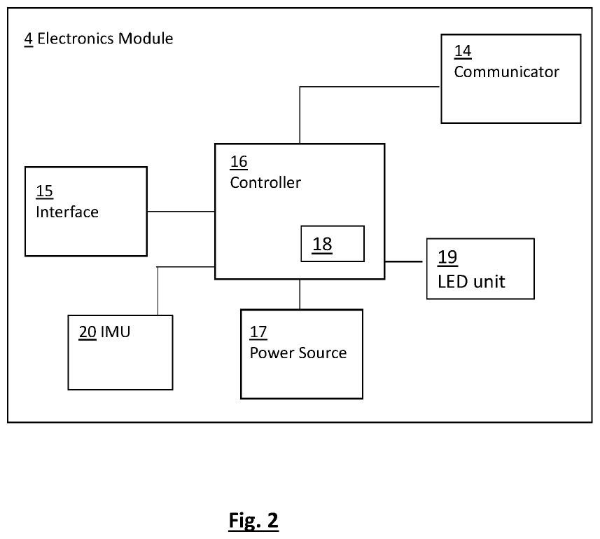

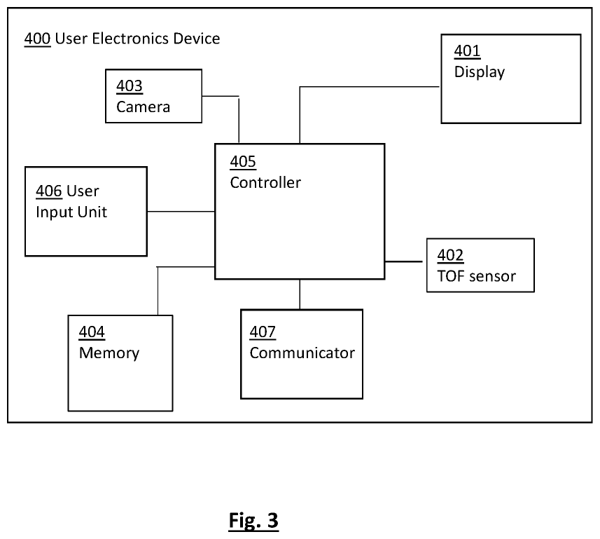

Referring to FIG. 2, there is shown a schematic diagram for the electronics module 4 of FIG. 1.

The electronics module 4 comprises an interface 15, a controller 16, a power source 17, a communicator 14, memory 18, an LED unit 19 and an inertial measurement unit (IMU) 20. The components are housed within a housing 22.

The interface 15 is arranged to communicatively couple with sensing components 2, 3 of the garment 1 (FIG. 1) so as to receive signals from the sensing components 2, 3. The controller 16 is communicatively coupled to the interface 15 and is arranged to receive the signals from the interface 15. The interface 15 may form a conductive coupling or a wireless (e.g. inductive) communication coupling with the electronics components of the wearable article

The power source 17 is coupled to the controller 16 and is arranged to supply power to the controller 16. The power source 17 may comprise a plurality of power sources. The power source 17 may be a battery. The battery may be a rechargeable battery. The battery may be a rechargeable battery adapted to be charged wirelessly such as by inductive charging. The power source 17 may comprise an energy harvesting device. The energy harvesting device may be configured to generate electric power signals in response to kinetic events such as kinetic events performed by a wearer of the garment 1. The kinetic event could include walking, running, exercising or respiration of the wearer. The energy harvesting material may comprise a piezoelectric material which generates electricity in response to mechanical deformation of the converter. The energy harvesting device may harvest energy from body heat of a wearer of the garment 1. The energy harvesting device may be a thermoelectric energy harvesting device. The power source may be a super capacitor, or an energy cell.

The communicator 14 is arranged to communicatively couple with the user electronic device 400 over a wireless communication protocol.

The communicator 14 may transmit activity data obtained from the sensing components 2, 3 to the user electronic device 400 either directly or via, for example, the server 200. The activity data may be a processed version of the signals obtained from the sensing components 2, 3.

In an example operation, the user electronic device 400 is brought into proximity with the electronics module 4. In response to this, the electronics module 4 is configured to energize the communicator 14 to transmit the first electronics module identifier and the second electronics module identifier to the user electronic device 400 over the wireless communication protocol. The wireless communication protocol may be a near field communication (NFC) protocol but is not limited to any particular communication protocol. Beneficially, this means that the act of the user electronic device 400 approaching the electronics module 4 energizes the communicator 14 to transmit the first electronics module identifier and the second electronics module identifier to the user electronic device 400. This provides a simple and intuitive mechanism for transmitting the first and second electronics module identifiers to the user electronic device 400 which does not require the user manually input the identifier via a user interface of the user electronic device 400 for example.

As mentioned above, the first electronics module identifier is a unique identifier for the electronics module 4 that enables the user electronic device 400 to uniquely identify the electronics module 4. In this example, the first electronics module identifier may be an address for the electronics module such as a MAC address or Bluetooth® address or may be a component of an address for the first electronics module identifier.

In some examples, the communicator 14 is a component of a passive tag such as a passive Radio Frequency Identification (RFID) tag or Near Field Communication (NFC) tag. These tags comprise an antenna as well as a memory which stores the information, and a radio chip. The user electronic device 400 is powered to induce a magnetic field in an antenna of the user electronic device 400. When the user electronic device 400 is placed in the magnetic field of the antenna of the communicator 14, the user electronic device 400 induces current in the antenna of the communicator 14. This induced current is used to retrieve the first electronics module identifier from the memory of the tag and transmit the same back to the user electronic device 400.

In other examples, the communicator 14 is not a component of a tag. In these examples, the electronics module 4 may detect a user electronic device 400 being brought into proximity with electronics module 4 based on factors such as through a sensor of the electronics module 4 or a current being induced in an antenna of the communicator 14. Once the electronics module 4 determines that the user electronic device 400 is in proximity with the electronics module 4, the controller 16 reads the first electronics module identifier and the second electronics module identifier from the memory 18 of the controller 16 or an external memory and energizes the communicator 14 to transmit the first electronics module identifier and the second electronics module identifier. Beneficially, this approach provides greater customisability and allows for different information and dynamically changing information to be transmitted by the communicator 14. That is, the information transmitted by the first antenna can be dynamically changed, e.g. to dynamically change the first electronics module identifier and the second electronics module identifier. This is because the controller 16 is able to update the content stored in the memory 18 which is not possible in a passive NFC or RFID tag. This is particularly beneficial if it is desirable to update or modify the first electronics module identifier and the second electronics module identifier that is transmitted to the user electronic device 400.

The communicator 14 is not limited to transmitting over the wireless communication protocols described above. The communicator 14 may be a mobile/cellular communicator operable to communicate the data wirelessly via one or more base stations and server 200. The communicator 14 may provide wireless communication capabilities for the electronics module 4 and enable the user electronics module 4 to communicate via one or more wireless communication protocols such as used for communication over: a wireless wide area network (WWAN), a wireless metroarea network (WMAN), a wireless local area network (WLAN), a wireless personal area network (WPAN), Bluetooth® Low Energy, Bluetooth® Mesh, Bluetooth® 5, Thread, Zigbee, IEEE 802.15.4, Ant, a near field communication (NFC), a Global Navigation Satellite System (GNSS), a cellular communication network, or any other electromagnetic RF communication protocol. The cellular communication network may be a fourth generation (4G) LTE, LTE Advanced (LTE-A), LTE Cat-M1, LTE Cat-M2, NB-IoT, fifth generation (5G), sixth generation (6G), and/or any other present or future developed cellular wireless network. A plurality of communicators may be provided for communicating over a combination of different communication protocols.

The electronics module 4 may comprise a Universal Integrated Circuit Card (U ICC) that enables the wearable article to access services provided by a mobile network operator (MNO) or virtual mobile network operator (VMNO). The UICC may include at least a read-only memory (ROM) configured to store an MNO/VMNO profile that the electronics module 100 can utilize to register and interact with an MNO/VMNO. The UICC may be in the form of a Subscriber Identity Module (SIM) card. The electronics module 100 may have a receiving section arranged to receive the SIM card. In other examples, the UICC is embedded directly into the controller 403. That is, the UICC may be an electronic/embedded UICC (eUICC). A eUICC is beneficial as it removes the need to store a number of MNO profiles, i.e. electronic Subscriber Identity Modules (eSIMs). Moreover, eSIMs can be remotely provisioned to electronics module 100. The electronics module 100 may comprise a secure element that represents an embedded Universal Integrated Circuit Card (eUICC).

The LED unit 19 comprises five digital RGB addressable LEDs 501a, 501b, 501c, 501d, 502. Four of the LEDs 501a, 501b, 501c, 501d form the second electronics module identifier 500, whilst the fifth LED 502 is used as a status indicator for the electronics module 4.

The status indicator LED 502 indicates, for example, whether the electronics module 4 is on or off, requires charging or other possible statuses.

Each RGB addressable LED comprises three emitters—one each of red, green and blue colour, and control electronics with connections for data-in, data-out and a clock and strobing signal. This enables each of the LEDs 501a, 501b, 501c, 501d, 502 to be controlled to emit a required colour and to strobe or flash as required. In particular, each of the second electronics module identifier LEDs 501a, 501b, 501c, 501d can be programmed to display a particular arrangement of coloured and/or flashing lights which is assigned to a particular electronics module 4, and thus the wearer, whilst the status LED 502 can be programmed to visually indicate the operational status of the electronics module 4. The arrangement defines the machine-readable code for a specific electronics module 4 and comprises an LED configuration comprising a sequence of colours and/or flashes that is assigned to that electronics module 4

The LED unit 19 is mounted within the electronics module 4 such that the emitted light is seen externally of the electronics module 4. As such, the machine-readable code is readable externally of the housing 20 of the electronics module 4.

The controller 16 is operable to control the LEDs 501a, 501b, 501c, 501d, 502 accordingly.

At start up, the controller 16 is operable to perform a scan of the environment, for example of the personal area network using Bluetooth®, to determine if there are other electronics modules within the personal area network and, if so, determines the machine readable code(s) assigned to those other electronics modules.

The controller 16 is then operable to assign an unassigned machine-readable code to the electronics module 4. The controller may use, for example, the next code in the look-up table in memory 18 to assign to the electronics module 4.

To mitigate against duplication of an assigned the same identifier, if two electronics modules do have the same identifier, the electronics module with the most battery charge would be assigned an updated pattern accordingly, as the electronics module with less battery charge is likely to be going back on charge sooner.

The electronics module 4 may then transmit details of its assigned machine-readable code over Bluetooth® so that other electronics modules can determine that this code is now assigned to an electronics module 4.

The IMU 20 is configured to measure the wearer's specific force, angular rate, and orientation of the wearer, using a combination of accelerometers, gyroscopes, and sometimes magnetometers.

The user electronic device 400 in the example of FIG. 1 is in the form of a mobile phone or tablet and comprises a communicator 407, a memory 404, a controller 405, a display 401, a first capturing device in the form of a camera 403, a user input unit 406 and a second capturing device in the form of a time-of-flight (ToF) sensor 402. The controller 405 provides overall control to the user electronic device 400. The communicator 407 transmits and receives various pieces of information required for communication with the server 200 and/or the electronics module 4 of the wearable assembly 100, under the control of the controller 405. The communicator 407 transmits the data to the server 200 and receives activity data from the server 200. The user input unit receives inputs from the user such as a user credential. The user input unit 406, may include a biometric sensor and/or touch sensitive display or other interface. The communicator 407 can also be configured to communicate with the electronics module 4.

The camera 403 captures the image of the environment including the wearable assembly 100, for example when being worn by the wearer. The camera 403 can be any conventional camera suitable for a user electronic device 400 and as well known in the art.

The storage stores information for the user electronic device 400.

The ToF sensor 402 is an infrared sensor. Infrared ToF sensors use a transmitted infrared signal which then senses the infrared signal reflected of distant objects and measures the time it takes for that infrared signal to bounce off of an object and back in order to make measurements of distance between the ToF sensor and the object. It can be used to create three-dimensional representations of objects sensed by the ToF sensor. In augmented reality applications ToF sensors are useful in measuring surroundings accurately in three dimensions. It also helps with object detection and recognition.

The display 401 is arranged to show a live view image of the environment captured by the camera and to display any objects or visualisations, for example in as an augmented reality display as will be described in further detail below. The display 401 may be a presence-sensitive display and therefore may comprise the user input unit. The presence-sensitive display may include a display component and a presence-sensitive input component. The presence sensitive display may be a touch-screen display arranged to provide the user interface.

The biometric sensor may be used to identify a user or users of device based on unique physiological features. The biometric sensor may be: a fingerprint sensor used to capture an image of a users fingerprint; an iris scanner or a retina scanner configured to capture an image of a users iris or retina; an ECG module used to measure the user's ECG; or the camera of the user electronic arranged to capture the face of the user. The biometric sensor may be an internal module of the user electronic device. The biometric module may be an external (stand-alone) device which may be coupled to the user electronic device by a wired or wireless link.

User electronic devices in accordance with the present invention are not limited to mobile phones or tablets and may take the form of any electronic device which may be used by a user to perform the methods according to aspects of the present invention. The user electronic device may be a mobile electronic device such as a smartphone, tablet personal computer (PC), mobile phone, smart phone, video telephone, laptop PC, netbook computer, personal digital assistant (PDA), mobile medical device, camera or wearable device. The wearable device may include a head-mounted device such as an Augmented Reality, Virtual Reality or Mixed Reality head-mounted device. The user electronic device may be desktop PC, workstations, television apparatus or a projector, e.g. arranged to project a display onto a surface.

The server 200 may be a single device or may comprise a plurality of distributed devices communicatively coupled to one another, e.g. as a cloud-based server such as cloud server network. The server 200 comprises an electronics module, a storage, and a controller. The controller provides overall control to the server 200. The electronics module transmits and receives various pieces of information required for communication with a user electronic device and/or garment under the control of the controller. The storage stores information for the server 200 such as the first and second electronics module identifier, activity data, and user credential information.

As previously described, the second electronics module identifier 500 provides a remote identifier for the electronics module 4 and also forms a primary AR marker and, comprises an arrangement of LEDs 501a, 501b, 501c, 501d on the outer face 21 of the housing 20 of the electronics module 4.

The second electronics module identifier LEDs 501a, 501b, 501c, 501d, may assume a configuration that is a combination of red, blue, green or unilluminated lights.

The second electronics module identifier LEDs 501a, 501b, 501c, 501d may be arranged in a matrix, grid or pattern.

The LEDs 501a, 501b, 501c, 501d can be configured to operate in the static RGB mode, in a non-static flashing or strobing mode, or a combination of the two.

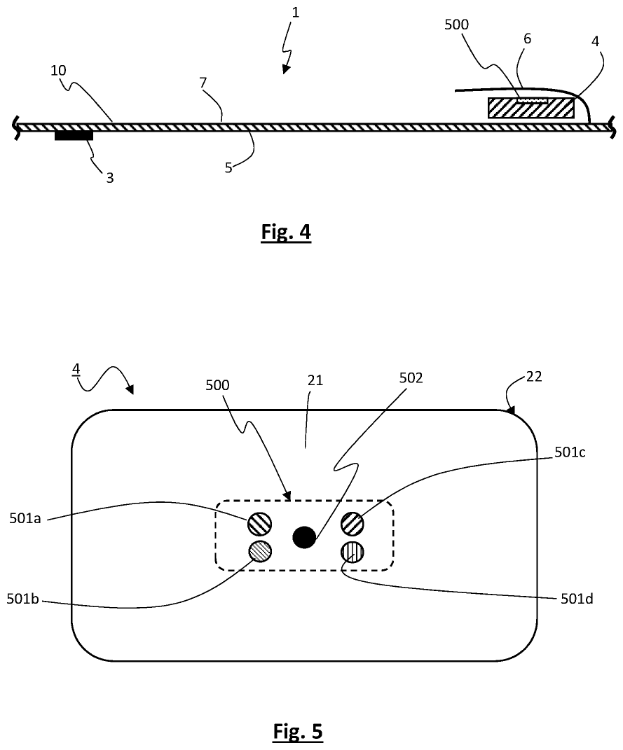

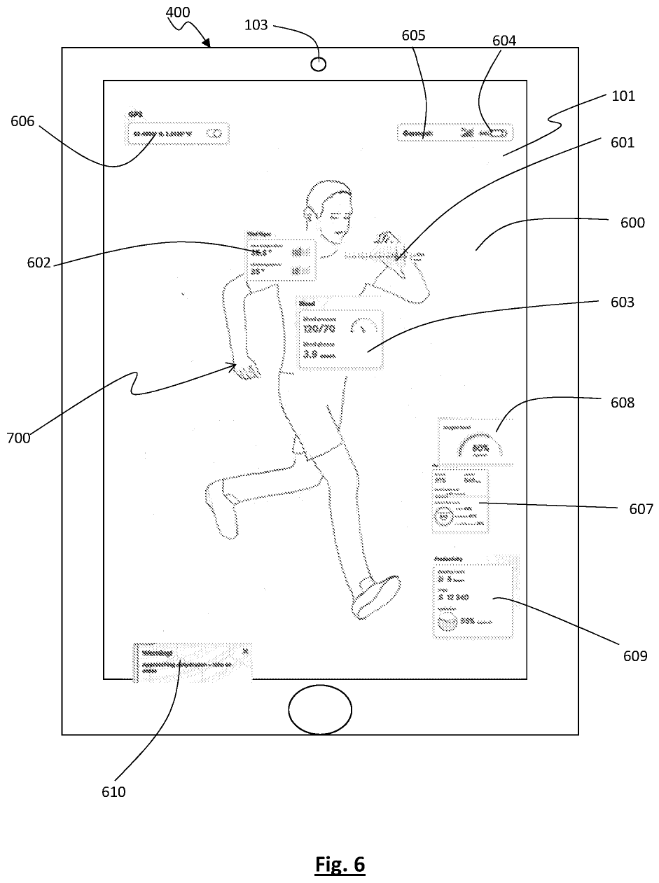

In FIG. 4, the LED arrangement comprises four LEDs 501a, 501b, 501c, 501d in a rectangular grid configuration with the status LED 502 centrally located. Each of the second electronics module identifier LEDs 501a, 501b, 501c, 501d can be in an on or off state and, when in an on state, can emit in a red, green, or blue (RGB) colour. The LEDs 501a, 501b, 501c, 501d can also be configured to switch between an on and off state at a predetermined rate to flash or strobe.

The second electronics module identifier LEDs 501a, 501b, 501c, 501d can be programmed to have a unique combination of colours, and/or a possible flashing or strobing sequence of the LEDs 501a, 501b, 501c, 501d. This unique combination can provide the second electronics module identifier for the electronics module 4. The term “colour” includes an LED being in an off state i.e. no colour.

An example of this could be a rectangular grid formation of four LEDs in which each one can be a red colour, one a green colour, one a blue colour, and one off without any flashing or strobing. With a combination of one each of these colour states at one of four different relative positions, there are 24 different permutations. This would be sufficient for a group of 24 electronics modules to each have a unique second electronics module identifier.

Adding flashing or strobing sequences would increase the number of permutations.

In use, the camera 403 of the user electronic device 400 can be used to capture an image of a wearer wearing a garment 1 in which the electronics module 4 is held in the pocket 13.

In capturing the image of the wearer, the camera 403 is also operable to capture the second electronics module identifier 500 which is visible on the electronics module 4. In this way, the arrangement of LEDs 501a, 501b, 501c, 501d define the machine-readable code which can be read by, and stored in, the user electronic device 400 and is readable externally of the electronics module 4. The controller 405 of the user electronic device 400 is configured to decode and store the second electronics module identifier 500 in the memory 404. The controller 405 is then configured to compare the second electronics module identifier 500 against the second electronics module identifiers stored in the memory 404 and to identify the first electronics module identifier associated with the second detected second electronics module identifier, and thus be able to identify the wearer of the electronics module 4 held in the garment 1.

As mentioned above the second electronics module identifier 500 forms an AR marker which may also act as a point of reference for the garment 1 and thus enables the position of the garment and the motion of the garment 1 over time to be monitored simply by capturing images of the garment.

The user electronic device 400 may then be configured to display an augmented reality visualization on the display 401 of the user electronic device 400 based on the identity of the wearer of the electronics module 4 held in the garment 1 as identified from the second electronics module identifier 500.

Specifically, the controller 405 is operable to access the activity data for the identified wearer and to display the activity data as an augmented reality visualization on the display 401.

Additional secondary AR markers 503 can be provided on the garment 1 at various locations to form anchor points to aid with overlaying AR visualisation, if required.

Once the first and second electronics device identifiers have been associated and stored for one or more electronics modules 4, for example during the set up sequence, the user electronic device 400 is in communication with the one or more electronics modules 4 and is able to receive activity data therefrom.

Because the association between the first and second electronics module identifiers has been formed, the user electronic device 400 is able to determine which electronics module 4 is associated with a particular wearer of the garment 1 in which the electronics module 4 is stored and thus to which wearer the received activity data relates to. In particular, the user electronic device 400 can obtain the first electronics module identifier with incoming activity data and compare this first electronics module identifier to the database 301 to determine the second electronics module identifier that the first electronics module identifier is associated with.

As an example, the user of the user electronic device 400 may be a coach of a sports team who desires to view activity data for a particular athlete. The display 401 of the user electronic device 400 may display activity data for a number of wearers at the same time, or wearers one-by-one in accordance with the AR markers 500, 503.

In an alternative, communication can be between the electronics module and the server 200 and the user electronics device 400 and the server 200.

Methods using both of these arrangements will be described below.

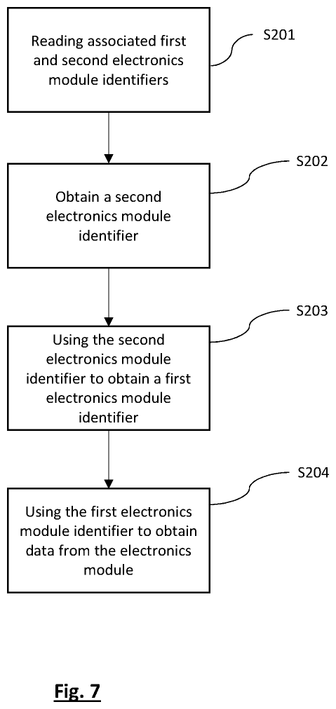

Referring to FIG. 6, there is shown an example user interface 600 displayed on the display 401 of the user electronic device 400.

The user interface 600 includes a display of a representation 700 of the wearer 706 of the garment 1. The displayed representation 700 of the wearer of the garment 1 is in the form of a live view image which can be a still or a video image as captured by the camera of the user electronic device 400.

The user interface 600 also includes representations of the activity data received by the user electronic device 400. The representation of the activity data in this example is the form of graphical representations or objects that overlay the representation 700 of the wearer 706.

The representation of the activity data can be anchored i.e. displayed at a position determined according to the location of the additional secondary markers 503 on the garment 1. In particular, the additional secondary markers 503 are fiducial markers that acts as a reference position for the garment 1 in relation to the wearer of the garment 1. The position of the representation 601 of the activity data to be displayed is determined using the position of the secondary marker 503 (x1, y1) in the representation 700 of the wearer and a predetermined displacement (x2, y2) from the secondary marker 503 to a feature of interest on the wearer such as the chest region or the arms. In particular, the position of the representation 601 of the activity to be displayed can be determined as (x1, y1)+(x2, y2). Displays which are arranged as determined by the locations of the secondary markers 501 may include, for example, an ECG trace and heartrate data 601, core body temperature and skin surface temperature 602, and blood pressure and blood glucose levels 603.

The user interface 600 of FIG. 6 can also display activity data for the wearer and other data for the garment 1 at positions which are not determined based on the location of the marker on the garment 1. In this exemplar embodiment, this includes: the signal strength 604 for the electronics module of the garment 1; the battery level 605 for a battery of the garment 1; GPS coordinate data 606; fat level, calories burned, blood lactate level as well as an indication of the type of calories burned 607; the oxygen level 608, and sleep tracking, step tracking and hydration level 609.

The user interface 600 can also displays warnings 610, indicating, for example when the wearer hydration levels are concerning.

Of course, the user interface 600 in FIG. 6 is just one example interface and other forms of bio data may be displayed to the user in a different way.

In an example use case, a sports coach may desire to monitor several players on a team. The coach is able to use an electronic device 400 to scan the second electronics module identifier 500 located on the electronics module 4 of the player to obtain activity data for the player. This enables the coach to quickly and easily ascertain information about the player related to their performance.

Each player wears one of the wearable assemblies 100 which comprises a garment 1 and an electronics module 4 that transmits activity data to the user electronic device 400.

This activity data can be transmitted to the user electronics device 400. either directly or via the server 200.

In some examples, the server 200 receives the activity data from the plurality of electronics modules 4 and, for one or a plurality of the electronics modules, transmits the activity data (which may be a processed version of the originally received activity data) and the first electronics module identifier to the user electronics device 400. In some examples, the activity data is transmitted directly to the user electronics device 400, for example using Bluetooth5®.

During an initial set up sequence, for each of the wearable assemblies 100, the user electronics device 400 reads the first electronics module identifier and the associated second electronics module identifier for a particular wearer and stores this on the user electronic device 400 or at the server 200.

The user electronics device 400 is then subsequently able to display the activity data along with identifying information for the wearer on the display 401 using the user interface 600 for example as described above received from the electronics module 4. The identifying information may include a username, picture or other identifying information.

In one example, the server 200 receives the activity data from the plurality of electronics modules 4. The operator of the user electronics device 400 may desire to view activity data for one or more of the electronics modules 4. To do this, the user uses the user electronics device 400 to read the second electronics module identifiers 500 for wearers wearing the electronics modules 4. The user electronics device 400 use the second electronics module identifier, and the stored association with a first electronics module identifier to identify the first electronics module identifier associated with the second electronics module identifier. The user electronics device 400 transmits the first electronics module identifier to the server 200 as part of a request for activity data. The server 200 transmits the activity data (which may be a processed version of the originally received activity data) for the electronics module identified by the first electronics module identifier to the user electronics device 400. The user electronics device 400 may then display the activity data along with identifying information for the wearer. The identifying information may include a username, picture or other identifying information. This approach enables the user electronics device 400 to determine which garment and thus which athlete incoming activity data relates to.

In alternative arrangements, the IMU 20 can determine the orientation of the wearer, which enables the controller 405 to configure the LEDs 501a, 501b, 501c, 501d to adopt the correct assigned configuration for the wearer's configuration so that the machine-readable code remains constant whatever orientation the wearer is in.

By identifying the relative orientation of the LEDs 501a, 501b, 501c, 501d and configuring the LEDs 501a, 501b, 501c, 501d accordingly, this would mitigate against two separate electronics modules being erroneously identified as having the same second electronics module identifier as a result of one of the electronics modules being at a different orientation to another and giving rise to the same apparent orientation of the second electronics module identifier on two different electronics modules.

Alternatively, one of the LEDs 501a, 501b, 501c, 501d could be programmed to blink a set number of times, or at a greater intensity, to identify itself as the orientation indicator to the observing camera 403.

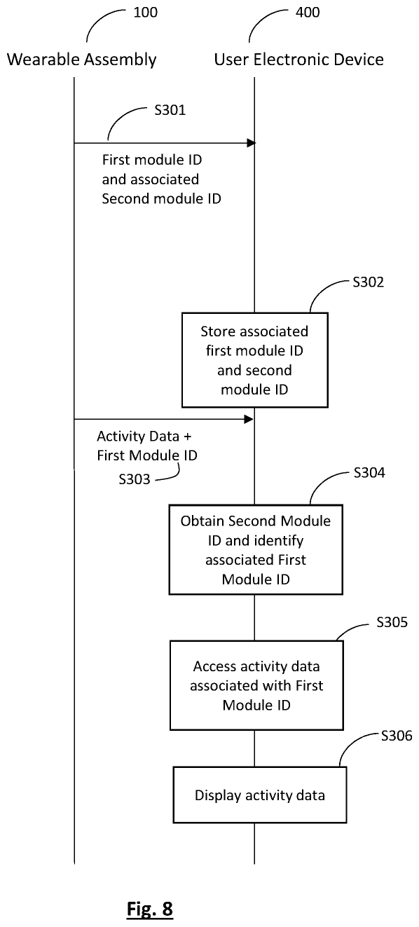

Referring to FIG. 7, there is shown an example method of accessing activity data from an electronics module of a wearable assembly.

Step S201 of the method comprises reading and storing a first electronics module identifier and an associated second electronics module identifier for an electronics module being used with a wearable article.

Step S202 of the method comprises obtaining a second electronics module identifier for an electronics module being used with a wearable article.

Step S203 of the method comprises using the second electronics module identifier to identify a first electronics module identifier for the electronics module associated with the second electronics module identifier.

Step S204 of the method comprises using the first electronics module identifier to obtain activity data for the wearer wearing the wearable article from the electronics module.

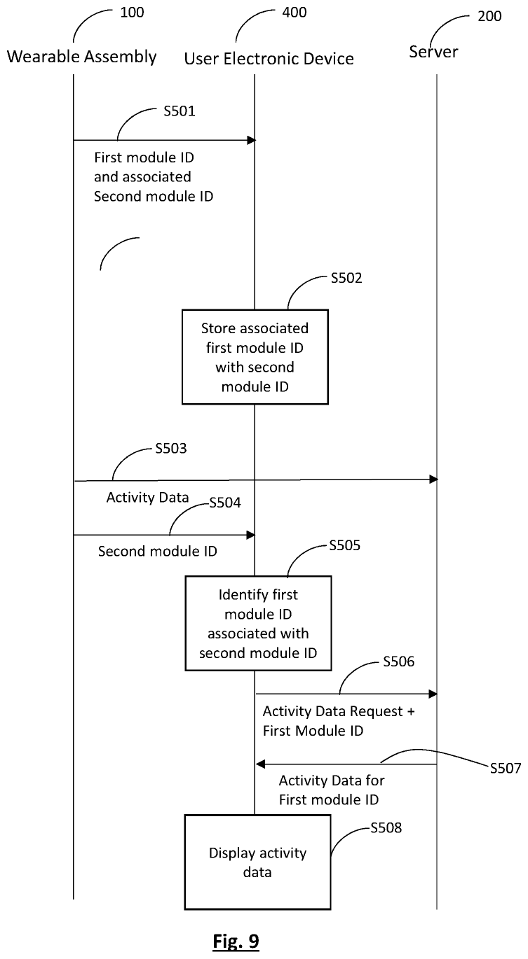

Referring to FIG. 8, there is shown a swim-lane flow diagram for an example method according to aspects of the present disclosure. The method is performed by a wearable assembly 100 and a user electronics device 400.

In step S301, the user electronics device 400 obtains a first electronics module identifier and an associated second electronics module identifier for the electronics module of the wearable assembly 100.

In step S302, the user electronics device 400 stores the associated first and a second electronics module identifier for the electronics module of the wearable assembly 100.

In step S303, the electronics module of the wearable assembly 100 transmits activity data and the first electronics module identifier to the user electronics device 400. In some examples, the first electronics module identifier is not transmitted as this information may be inferred by the user electronics device 400 based on factors such as the properties of the communication and the communication channel used by the electronics module.

In step S304, the user electronics device 400 obtains a second electronics module identifier from a wearable assembly in response to the user electronics device 400 scanning, or imaging the wearer of the electronics module 400 and reading the machine-readable code 500 from the electronics module 4 as described above, and the user electronic device 400 identifies the first electronics module identifier from the obtained second electronics module identifier in accordance with the stored association between the first electronic module identifier and the obtained second electronics module identifier.

In step S305, the user electronics device 400 access the activity data for the identified first electronics module identifier.

At step S306 the user electronics device displays the activity data, optionally along with identifying information for the wearer.

Referring to FIG. 9, there is shown a swim-lane flow diagram for an example method according to aspects of the present disclosure. The method is performed by a wearable assembly 100, user electronics device 400 and server 200.

In step S501, the user electronics device 400 obtains a first electronics module identifier and an associated second electronics module identifier for the electronics module of the wearable assembly 100.

In step S502, the user electronics device 400 stores the associated first and a second electronics module identifier for the electronics module of the wearable assembly 100.

In step S503 the electronics module of the wearable assembly 100 transmits activity data and optionally the first electronics module identifier to the server 200. In some examples, the first electronics module identifier is not transmitted as this information may be inferred by the server 200 based on factors such as the properties of the communication and the communication channel used by the electronics module.

In step S504, the user electronics device 400 obtains a second electronics module identifier from a wearable assembly in response to the user electronics device 400 scanning, or imaging the wearer of the electronics module 400 and reading the machine-readable code 500 from the electronic module 4 as described above.

In step S505, the user electronic device 400 identifies the first electronic module identifier from the obtained second electronics module identifier in accordance with the stored association between the first electronic module identifier and the obtained second electronics module identifier.

In step S506 the user electronic device 00 transmits an activity data request, along with the first electronics module identifier identified in step S505, to the server 200.

In step S507, the server 200, in response to the request in step S408, transmits the requested activity data, to the user electronics device 400.

In step S508, the user electronic device 400 displays the activity data, for example in an augmented reality view.

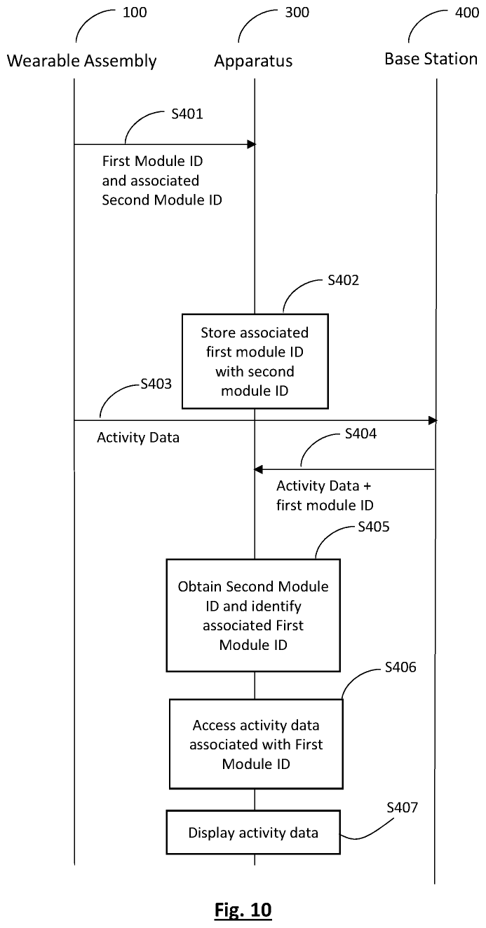

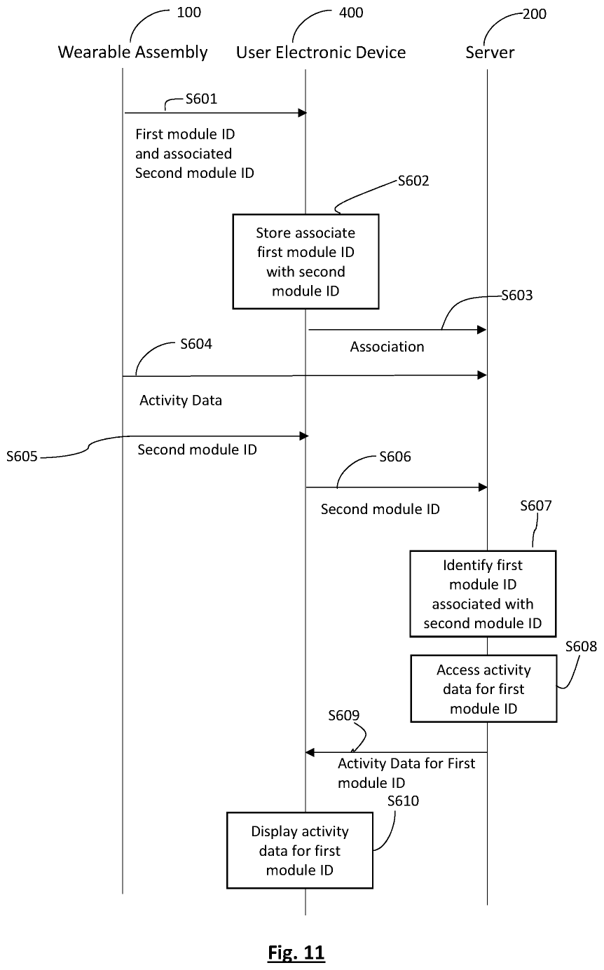

Referring to FIG. 10, there is shown a swim-lane flow diagram for an example method according to aspects of the present disclosure. The method is performed by a wearable assembly 100, user electronics device 400 and server 200.

In step S401, the user electronics device 400 obtains a first electronics module identifier and an associated second electronics module identifier for the electronics module of the wearable assembly 100.

In step S402, the user electronics device 400 stores the associated first and a second electronics module identifier for the electronics module of the wearable assembly 100.

In step S403, the electronics module of the wearable assembly 100 transmits activity data and a first electronics module identifier to the server 200. In some examples, the electronics module identifier is not transmitted as this information may be inferred by the server 200 based on factors such as the properties of the communication and the communication channel used by the electronics module.

In step S404, the server 200 transmits the received activity data and the first electronics module identifier to the user electronic device 400.

In step S405, the user electronics device 400 obtains a second electronics module identifier from a wearable assembly in response to the user electronics device 400 scanning, or imaging the wearer of the electronics module 400 and reading the machine-readable code 500 from the electronic module 4 as described above.

The user electronic device 400 then identifies the first electronic module identifier from the obtained second electronics module identifier in accordance with the stored association between the first electronic module identifier and the obtained second electronics module identifier.

In step S406, the user electronics device 400 access the activity data for the identified first electronics module identifier.

In step S407, the user electronic device 400 displays the activity data, optionally along with identifying information for the user.

Referring to FIG. 11, there is shown a swim-lane flow diagram for an example method according to aspects of the present disclosure. The method is performed by a wearable assembly 100, user electronics device 400 and server 200.

In step S601, the user electronics device 400 obtains a first electronics module identifier and an associated second electronics module identifier for the electronics module of the wearable assembly 100.

In step S602, the user electronics device 400 stores the associated first and a second electronics module identifier for the electronics module of the wearable assembly 100.

In step S603, the user electronics device 400 transmits the associated first and second electronics module identifiers to the server 200.

In step S604, the electronics module 4 of the wearable assembly 100 transmits activity data to the server 200 optionally along with the first electronics module identifier.

In step S605, user electronics device 400 obtains a second electronics module identifier from a wearable assembly 100 in response to the user electronics device 400 scanning, or imaging the wearer of the electronics module 400 and reading the machine-readable code 500 from the electronic module 4 as described above.

In step S606, the user electronic device 400 transmits the second electronics module identifier to the server 200.

In step S607, the server 200 uses the second electronics module identifier to identify a first electronics module identifier for an electronics module associated with the second electronics module identifier.

In step S608, the server 200 uses the first electronics module identifier to access activity data for the wearer wearing the electronics module 4.

In step S609, the server 200 transmits the accessed activity data for the wearer wearing the electronics module 4.

In step S610, the user electronics module 4 displays the activity data, optionally along with identifying information for the user.

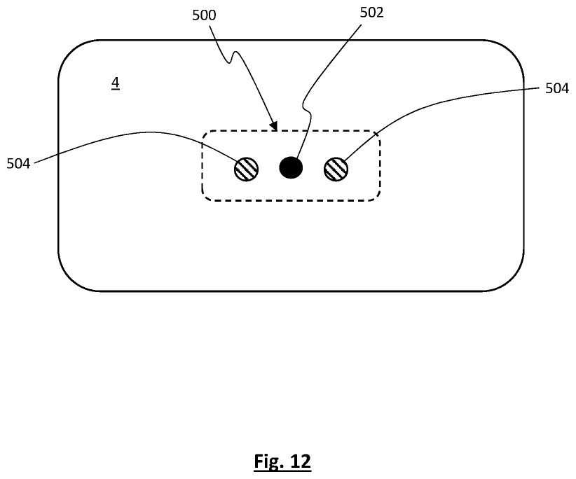

In an alternative embodiment, the second electronics module identifier 500 may comprise one or more infra-red (IR) LEDs 504. In the embodiment illustrated schematically in FIG. 12, the second electronics module identifier 500 comprises two IR LEDs 504 placed either side of the status LED 502.

The two IR LEDs 504 are configured to turn on and off in quick succession i.e. to blink at a predetermined rate. The IR LEDs 504 can be programmed to blink at the predetermined rate and in a predetermined sequence, which can be selected to be associated with, and unique to, the second electronics module identifier 500.

The IR signal from the IR LEDs 504 can be detected by the time of flight sensor 402 in the user electronic device 400 and the information processed by the controller of the user electronic device 400 to determine the second electronics module identifier.

A third solution, which relies on an ensured unobstructed view, would be to cycle the LEDs (RGB or IR) in an on-off sequence to convey a UID to the observing camera.

The properties of each of the LEDs 501a, 501b, 501c, 501d; 504 may be programmed dependent upon the determined orientation of the electronics device 4. The orientation of the electronics module 4 can be determined, for example, using an accelerometer or other suitable motion sensor and the states of the LEDs be altered to ensure that the relative orientations of the LEDs remain the same as captured by the user electronic device 400.

While the particular examples mentioned above refer to wearable articles in the form of garments, it will be appreciated that the present disclosure is not limited to such examples and other forms of wearable article are within the scope of the present disclosure. The wearable article may be, for example, any form of electronic device which may be worn by a user such as a smart watch, necklace, bracelet, or glasses. The wearable article may be a textile article.

While the examples mentioned above refer to non-visual symbols operating in the infrared part of the electromagnetic spectrum, other regions of the electromagnetic spectrum could be utilised.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-21. (canceled)

22. An electronics module for a wearable assembly, the electronics module comprising:
a housing;
a controller housed with the housing and arranged to interface with a sensing component of the wearable assembly so as to receive activity data associated with a wearer wearing the wearable assembly; and
a communicator housed within the housing and arranged to communicate a first electronics module identifier and an associated second electronics identifier to an external apparatus over a wireless communication protocol, wherein the second electronics module identifier comprises a machine-readable code, the machine-readable code being readable externally of the housing.

23. The electronics module for a wearable assembly according to claim 22, wherein the machine-readable code comprises an arrangement of light emitting diodes.

24. The electronics module for a wearable assembly according to claim 23, wherein the light emitting diodes are configured to illuminate in a pre-determined pattern or sequence.

25. The electronics module for a wearable assembly according to claim 23, wherein the arrangement includes an infra-red light emitting diode.

26. The electronics module for a wearable assembly according to claim 22, wherein the second electronics module identifier is a fiducial marker.

27. A method comprising:
reading a first electronics module identifier and an associated second electronics module identifier for at least one electronics module;
storing the associated the first and second electronics module identifiers;
obtaining activity data from one of the at least one electronics module;
obtaining a second electronics module identifier from one of the least one electronics module;
identifying the first electronics module identifier associated with the obtained second electronics module identifier;
accessing activity data for the identified first electronics module identifier; and
displaying the accessed activity data for the identified first electronics module identifier, wherein the step of obtaining the second electronics module identifier comprises reading a machine-readable code of the one of the at least one electronics module externally of the at least one electronics module.

28. The method according to claim 27, wherein the step of reading the machine-readable code comprises imaging a visual marker provided on a housing of the at least one electronics module.

29. The method according to claim 27, wherein the step of reading the machine-readable comprises detecting a non-visual signal emitted by the at least one electronics module.

30. The method according to claim 27, further comprising displaying the activity data along with identifying information for the wearer wearing the at least one electronics module.

31. The method according to claim 30, wherein the displaying of the activity data is displayed in accordance with the second electronics module identifier.

32. The method according to claim 30, further comprising: reading at least one secondary display marker on the wearable article and displaying the activity data in accordance with the at least one secondary marker.

33. The method according to claim 27, further comprising:
receiving activity data and first and second electronics module identifiers from a plurality of electronics modules; and
for at least one of the plurality of electronics modules, obtaining a second electronics module identifier;
identifying a first electronics module identifier associated with the at least one of the plurality of electronics modules; and
accessing activity data for the identified first electronics module identifier associated with the at least one of the plurality of electronics modules.

34. The method according to claim 27, wherein the activity data is received indirectly from the electronics module via an external apparatus.

35. The method according to claim 27, wherein the obtained second electronics module identifier is transmitted to an external apparatus, and the step of the identifying the first electronics module and accessing the activity data is carried out at the external apparatus, the method further including the step of transmitting the activity data from the external device for display.

36. A computer program comprising instructions which, when executed by a computer apparatus, cause the computer apparatus to perform the method according to claim 27.

37. An apparatus comprising:
a first reader arranged to read a first electronics module identifier and an associated second electronics module identifier for an electronics module;
a second reader arranged to read a second electronics module identifier from at least one electronics module;
a memory for storing the associated the first and second electronics module identifiers;
a display; and
a controller being configured to:
obtain activity data from the at least one electronics module;
obtain the second electronics module identifier read by the second reader from the at least one electronics module;
identify the first electronics module identifier associated with the obtained second electronics module;
access activity data for the first electronics module identifier; and
display the accessed activity data for the first electronics module identifier on the display, wherein the second reader is arranged to read a machine-readable code of the at least one electronics module externally of a housing of the electronics module.

38. The apparatus according to claim 37, wherein the second reader is an image capturing device configured to image a visible machine-readable code on the housing of the at least one electronics module.

39. The apparatus according to claim 37, wherein the second reader is an infra-red sensor configured to detect an infra-red signal emitted by the second electronics module identifier to determine the machine-readable code from the detected infra-red signal.

40. The apparatus according to claim 37, wherein the controller is operable to obtain activity data from the at least one electronics module; and to identify a wearer wearing the at least one electronics module by identifying the second electronics module identifier associated with the at least one electronics module identifier.

41. The apparatus according to claim 40, wherein the apparatus includes a display, and the controller is configured to display the activity data along with identifying information for the wearer.

42. A wearable assembly including an electronics module according to claim 22.
